(19) United States
(12) Patent Application Publication
(10) Pub. No.: US 2010/0051674 A1
(43) Pub. Date: Mar. 4, 2010

(54) WATER-REPELLANT AND GAS BARRIER COMPOSITE MATERIAL

(76) Inventors: Michel Labbé, Victoriaville (CA); Daniel Morel, Kingsey Falls (CA)

Correspondence Address: OGILVY RENAULT LLP, 1, Place Ville Marie, SUITE 2500, MONTREAL, QC, H3B 1R1, CA

(21) Appl. No.: 12/439,687

(22) PCT Filed: Sep. 26, 2007
(86) PCT No.: PCT/CA2007/001725

§ 371 Date: Mar. 3, 2009

Related U.S. Application Data
(60) Provisional application No. 60/847,116, filed on Sep. 26, 2006.

(51) Int. Cl. B65D 5/42; B32B 3/00; B32B 3/28; B32B 3/12; B32B 37/00; B29C 47/00; B32B 27/34; B32B 21/08

(52) U.S. Cl. 229/5.5; 428/174; 428/182; 428/116; 156/60; 156/244.11; 428/475.5; 229/5.81

(57) ABSTRACT

A water-repellant and gas barrier composite material includes a core portion and a face member mounted to one of the surfaces of the core portion. The core portion has a wood fiber based geometrically patterned structure defining two spaced-apart substantially planar surfaces and including an hydrophobic additive. The face member has a wood fiber based linerboard including an hydrophobic additive and a nylon coating film on a surface of the wood fiber based linerboard.

### CROSS-REFERENCE TO RELATED APPLICATIONS

This application claims priority of U.S. provisional patent application(s) 60/847,116, the specification of which is hereby incorporated by reference.

### BACKGROUND OF THE INVENTION

1) Field of the Invention

The present invention relates to a material for packaging applications and, more particularly, to a substantially water repellant and gas barrier composite material that can be used to manufacture containers, such as perishable good container, for instance.

2) Description of the Prior Art

Several products have to be stored and/or transported from their production site to a consummation site in containers having water-repellant properties. The water-repellant properties protect the content of the container against liquid and water vapor infiltration, among others. They should also have gas barrier properties to prevent gas infiltration and odor release.

To reduce the storing and/or transportation costs, the container material should be lightweight, strong enough to safely carry the goods, inexpensive, and, preferably, recyclable or repulpable for environmental concerns.

For cost and weight concerns, most containers are paperboard containers which are impregnated with wax. In addition to resist to water infiltration, the resulting box has adequate oil, grease, and gas vapor properties. However, they can not be mixed with conventional paperboard containers to be recycled. They have to be sent to landfill sites to be buried. If mixed inadvertently, they creates considerable trouble to the recycling process.

There is thus a need for lightweight packaging materials with gas barrier, water repellant and adequate mechanical properties which can be recycled.

### SUMMARY OF THE INVENTION

It is therefore an aim of the present invention to address the above mentioned issues.

According to an aspect, there is provided a water-repellant and gas barrier composite material comprising: a core portion having a wood fiber based geometrically patterned structure defining two spaced-apart substantially planar surfaces and including an hydrophobic additive; and a face member mounted to one of the surfaces of the core portion, having a wood fiber based linerboard including an hydrophobic additive and a nylon coating film on a surface of the wood fiber based linerboard.

According to another aspect, there is provided a method for manufacturing a water-repellant and gas barrier composite material. The method comprises: applying a nylon coating film on a surface of a wood fiber based linerboard to obtain a face member, the linerboard being substantially water-repellant; and bonding the face member to a surface of a core portion having a wood fiber based geometrically patterned structure, the core portion being substantially water-repellant.

According to another aspect, there is provided a water-repellant and gas barrier composite material comprising: a wood fiber based linerboard and a nylon coating film bonded to a surface of the wood fiber based linerboard, the linerboard being substantially water-repellant.

According to a further aspect, there is provided a container having a peripheral wall and a bottom wall, at least one of said walls comprising: a core portion defining two surfaces spaced-apart from one another, the core portion having a wood fiber based geometrically patterned structure and being impregnated with an hydrophobic additive; and at least one face member mounted to at least one surface of the core portion, at least one face member including a wood fiber based linerboard impregnated with an hydrophobic additive and a nylon coating film laminated to a surface of the wood fiber based linerboard.

In this specification, the terms “water repellant”, “water resistant” or “hydrophobic” are intended to mean the tendency to repel, block or, in any event, not transmit or absorb any significant quantity of liquid water in normal use. In other words, these terms identify a liquid water-blocking property sufficient for packing intended for goods. The term “grease resistant” is intended to mean the character of repelling, blocking or, in any event, not transmitting or absorbing any significant quantity of grease or oil, such as blood or animal grease in normal use. The term “gas barrier” refers to the character of not permitting passage of gases therethrough.

### BRIEF DESCRIPTION OF THE DRAWINGS

FIG. 1 is a perspective view, partly sectioned, of a water-repellant and gas barrier composite material in accordance with an embodiment of the invention, wherein the core portion includes a corrugated layer;

FIG. 2 is a flow chart illustrating schematically a method for manufacturing the water-repellant and gas barrier composite material;

FIG. 3 is a flow chart illustrating schematically an alternative method for manufacturing the water-repellant and gas barrier composite material;

FIG. 4 is a flow chart illustrating a manufacturing process for manufacturing the water-repellant and gas barrier composite material;

FIG. 5 is a flow chart illustrating another manufacturing process for manufacturing the water-repellant and gas barrier composite material; and

FIG. 6 is a perspective view, partly sectioned, of a container manufactured with a water-repellant and gas barrier composite material in accordance with another embodiment.

It will be noted that throughout the appended drawings, like features are identified by like reference numerals.

### DETAILED DESCRIPTION

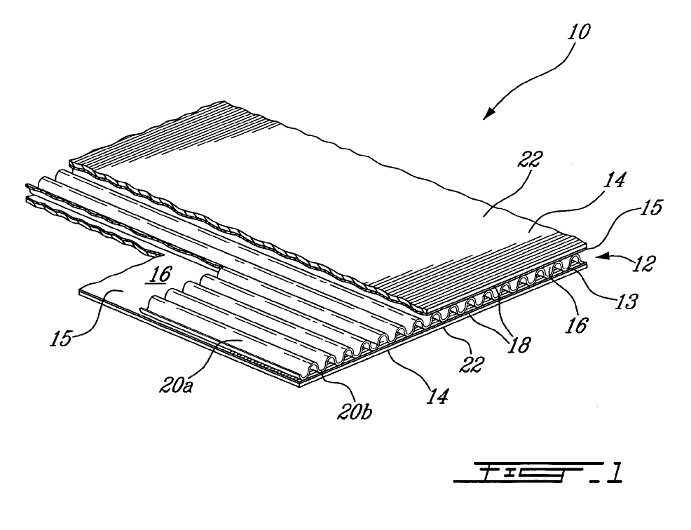

Referring now to the drawings and, more particularly, referring to FIG. 1, it will be seen a water-repellant and gas barrier composite material 10, or panel or combination, in accordance with an embodiment.

The composite material 10 includes a core portion 12 and two face members 14. The core portion 12 includes a corrugated layer 13, also called “pleated”, a geometrically patterned structure, made of a wood fiber based material such as, without being limitative, paperboard, cardboard, kraft paper, recycled paper, medium, chipboard, bleached or not, for instance. The corrugated layer 13 defines two opposite substantially planar surfaces 20a, 20b, spaced-apart from one another. Flute tops and bottoms respectively define a first and a second substantially planar surfaces 20a, 20b.

The face members 14 include two linerboards 15, each having an inner surface 16, an outer surface 18, and a nylon layer 22. The inner faces 16 of the linerboards 15 are bonded to a respective one of the surfaces 20 of the core portion 12. As for the corrugated layer 13, the linerboards 15 can be made of any wood fiber based material such as, without being limitative, paperboard, cardboard, kraft paper, recycled paper, medium, chipboard, bleached or not, for instance.

Each nylon layer 22 is bonded, as a coating, to a respective one of the outer surface 18 of the linerboards 15.

Both the corrugated layer 13 and the linerboards 15 are impregnated with or include an hydrophobic or water-repellant additive, as it will be described in more details below.

The combination of the impregnation of the corrugated layer 13 and the linerboards 15 and the juxtaposition of the nylon layers 22 to the outer surface 18 of the linerboards 15 provides substantial oil, grease, gas and water vapor barrier properties and substantial resistance to liquids to the composite material 10.

As it will be described in more details below, several water-repellant additives can be used to impregnate the core portion 12 and the linerboards 15. The core portion 12 and the linerboards 15 can also be protected by a combination of several hydrophobic additives. Moreover, several manufacturing processes can be used to add the water-repellant additive to the core portion 12 and the linerboards 15 and apply a nylon coating to the linerboards 15.

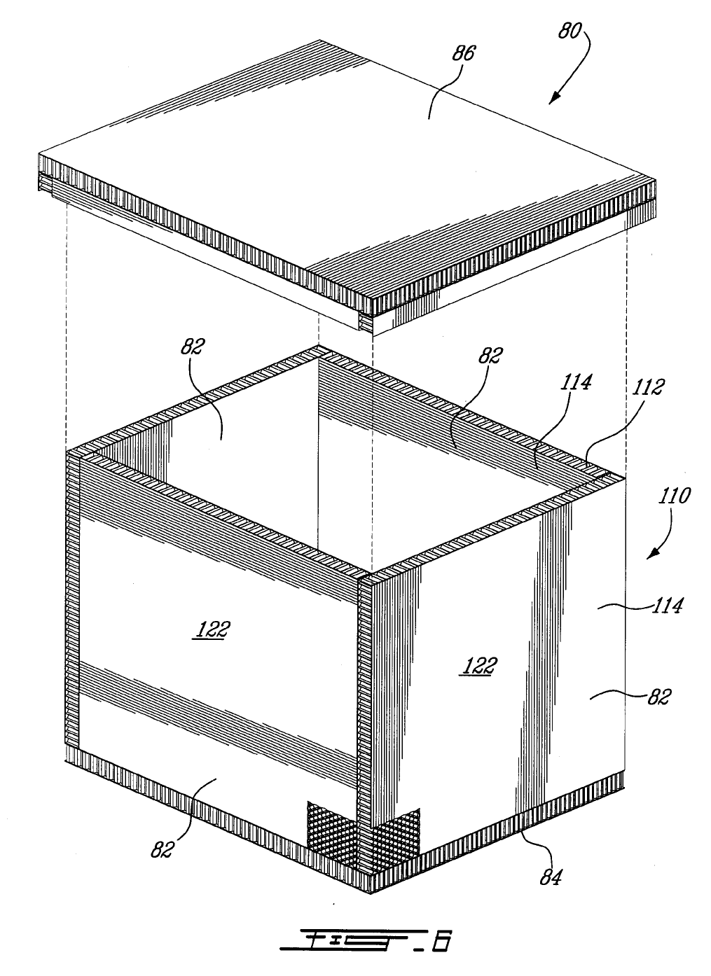

Furthermore, several structural alternatives can be foreseen to the embodiment shown in FIG. 1. For example, without being limitative, in an alternate embodiment, the corrugated layer of the core portion 12 can be replaced by any other geometrically patterned structure such as a honeycomb type material 24, as shown in FIG. 6, which provides air spaces therein and strengthen the composite material, for instance. It can also be an embossing. It can also include a combination of several geometrically patterned structure, such as a combination of corrugated layer(s), honeycomb material layer(s), and embossed.

As it will be appreciated, the number and the height of the flutes of the corrugated layer 13 can vary in accordance with the user's needs. Similarly, for an honeycomb core portion, the diameter and the height of the cells can be modified to obtain predetermined mechanical properties. The basis weight, or grammage, of the wood fibber based material of the linerboards and the core portion can also vary in accordance with the user's needs. They can vary between 30-450 g/m², for instance.

It is appreciated that the linerboards 15 can have a nylon coating on both surfaces, as shown in FIG. 1, that only one linerboard 15 can include a nylon coating, as shown in FIG. 6, or any possible combinations thereof. The nylon layer 22 can also be provided on the inner surface 16 of the linerboard 15.

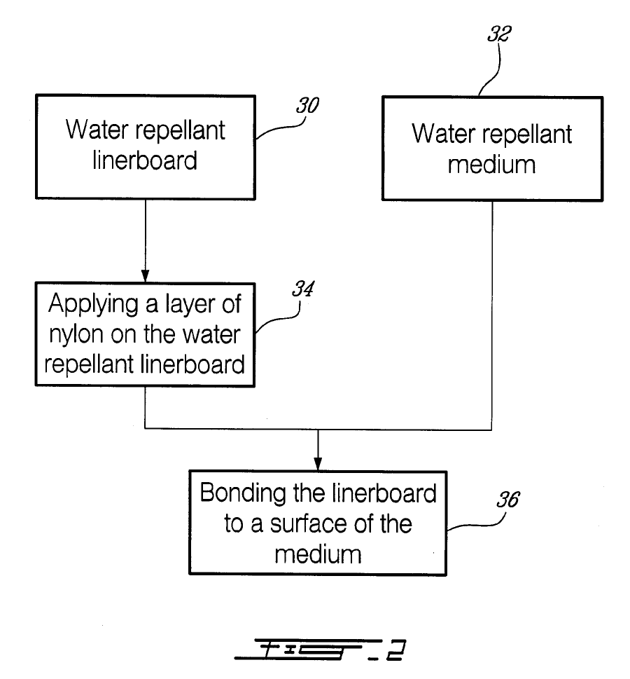

In reference to FIG. 2, a method for manufacturing a water-repellant and gas barrier composite material is described. First, in steps 30 and 32, at least one linerboard and a geometrically patterned layer, i.e. the core portion, having water-repellant properties are provided.

The addition of the water-repellant agent to the linerboard and the geometrically patterned structure can be carried out during the papermaking process such as paper machine wet-end addition with cellulosic fibers, at the size press, at the calender stack, for instance. Another water-repellent agent can be added by a coating process directly to the paper machine, in a second process at the coater or by extrusion, for instance. In an embodiment, the water-repellant agent, which can be a polymer, is added as a size press addition to make the linerboard and the geometrically patterned layer water and humidity resistant.

For example, using a rod coater, a water repellant coating can be applied to the top of the impregnated linerboard. The coating weight can be controlled by the rod size. The amount of coating can varied from 5 g/m2 to 30 g/m2, on a dry basis, the coating solids varied from 10-60% of solids. Other main coating technologies used for the application of the water base coatings are the blade coater, rolls applicators, annilox rolls and air knife, and any type of coating technologies used in the pulp and paper processes.

In an embodiment, both the linerboard and the geometrically patterned layer are impregnated with the hydrophobic agent. One or both the linerboard and the geometrically patterned layer can also include an hydrophobic coating, i.e. being coated with an hydrophobic substance.

When added to the paper machine at the size press, the hydrophobic agent can be applied as a solution of water-repellant polymers at a temperature ranging between 70 and 160° F., for instance. It can be pumped directly to the size press and then applied onto the paper by the size press or added and mixed in a size-press starch solution, for instance. The addition level of the hydrophobic polymer may vary from 20 to 50 kg/ton of paper to achieve various degree of water/humidity resistance.

Several hydrophobic or water-repellant agents can be used such as hydrophobic acrylics, hydrophobic polymers, or sizing agents. Chemical groups that lend to make substance hydrophobic include —CH2- chains and rings (hydrocarbons). Hydrophobic polymers such as polyethylene, polyvinyl chloride, polypropylene, polycarbonates, polyethylene terephtalate, and the like can be used. For example, without being limitative, the following products can also be used: Spectra-Guard® 763-AGH; Spectra-Guard® 763B (styrene butadiene acrylic); Spectra-Shield® 44; Spectra-Guard® 3000; EvCote® CMA-100 (polyethylene terephtalate emulsion); FIBREMAX® 105B (acrylic emulsion); and Mica® 1164 (ethylene acrylic acid). The Spectra-Guard® products are acrylic emulsions.

Sizing agents can be used alone or can assist with the performance of another hydrophobic agent. The sizing agent is also referred herein as an hydrophobic/water-repellent agent/additive. The sizing agent can be a natural agent such as rosin, starch, protein base, for instance, a semi-synthetic agent such as modified starch or mixtures of starch and PVA (polyvinyl alcohol) or CMC (carboxymethyl cellulose), for instance, or a synthetic agent such as polyacrylates, modified polyesters, styrenes, maleic acid copolymers, PVOH, alkyl ketene dimer (AKD) and alkenyl succinic anhydrides (ASA), for instance. Sizing agents such as, without being limitative, alkyl ketene dimer (AKD) and alkenyl succinic anhydrides (ASA), can be added to wet fibers, or pulp, in predetermined proportions at the wet end of the paper machine in the range from 0.25 to 10 kg/ton of paper, for instance. Adding the additive to the fiber mass pulp ensures the additive penetration. For example, AKD can be added in proportions varying between 0.5 and 3 kg/ton, for instance. It can be diluted before being added to the fiber mass pulp in accordance with the paper machine characteristics. An emulsifying agent, such as acrylamid polymers or modified starch, for instance, can be added simultaneously with the sizing agent.

The purpose of the addition of the hydrophobic agent to the linerboard(s) and the core layer is to achieve a substantially water/humidity resistant composite material. It also prevents edge wicking, i.e. the absorption of liquids from the edges of a composite material panel, as it will be described in more details below.

The structure and composition of the linerboard can vary in accordance with the user's needs. For example, without being limitative, the linerboard can be a laminated linerboard having several plies of linerboard adhered to one another for increased structural stability. It is appreciated that the linerboard can also include a single ply. If the linerboard is a laminated linerboard, a sizing agent, such as AKD, for instance, can be applied to the central plies while another hydrophobic agent, such as Spectra-Guard® 763B, for instance, can be applied to the outer surfaces of the linerboard with a size press. In the above described embodiment, AKD is a water repulsing agent and allow the control of the Spectra-Guard® 763B penetration rate to keep the latter proximate to the surfaces. In an embodiment, the ply number wherein AKD is added depends on the final basis weight of the linerboard. The combination of the water repellant additive and the sizing agent prevents edge wicking and prepares the outer surfaces to receive another coating. The resulting linerboard can be repulpable and recyclable. It offers substantial protection against water, oil, and grease. The water repellent additive added between the plies impregnates the plies.

A similar manufacturing process can be applied to manufacture the geometrically patterned layer of the core portion.

In an additional step (not shown), a coating, such as an off-machine coating like air knife, anilox, flexographic, roll coater, jet coater, rod coater, for instance, of an hydrophobic agent can be applied. The coated water-repulsing agent can be the same than the impregnated water repulsing agent or it can be another agent. The water-repellent coating increases humidity resistance and mechanical properties of the resulting composite material.

Then, in step 34, a nylon coating is applied to a surface of the linerboard. The nylon coating can be extruded on a surface of the linerboard since it resists to temperatures higher than 350° F. For example, it can be extrude on a single surface of the linerboard or on both surfaces of the linerboard. It can also be co-extruded with another material such as the water vapor barrier polymer. The term “extrusion” or the term “extruding” is intended to include coextrusion, extrusion coating, or combinations thereof. For example, without being limitative, on a linerboard having a basis weight of 40 g/square meter (8 lbs/1000 square feet), a coextrusion of 20 g/square meter of anhydride-modified HDPE and 20 g/square meter of nylon can be applied. The nylon coating provides substantial water, grease, and acid resistance, substantial gas barrier properties, and substantially prevent gas absorption. Moreover, it provides substantial resistance to cold storage.

In an alternative embodiment, the nylon coating, such as a nylon film, can be laminated or bonded to the linerboards with an adhesive such as, without being limitative, water based adhesives and hot melts. Moreover, two panels having a nylon coating can be bonded together for manufacturing a box, for example, since nylon coatings can be gluable.

Then, the face member, including the linerboard and the nylon coating, is bonded to a surface of the core portion in step 36. The resulting composite material is highly crush resistant. Bonding of the face member(s) to the core portion can be accomplished by any appropriate methods such as by gluing. For a corrugated layer, the additive can be applied either on the flute extremities, which define the surfaces of the core portion, or on the linerboard.

Several adhesives can be used to bond the face members to the core portion. For example, without being limitative, adhesives such as water-based adhesive, polyvinyl alcohol (PVOH), polyvinyl acetate (PVA), acrylic, stamp glue, dextrin, and polyurethane can be used to assemble components together. Hot melt adhesives such as polyolefin and ethylene vinyl acetate (EVA) can also be used. In some embodiments, it might be desirable to use a degradable or a repulpable adhesive. In other embodiments, it might be desirable to use an adhesive that remains on the surfaces of the geometrically patterned structure of the core portion or an adhesive that bonds very rapidly. It is also appreciated that a pressure-sensitive adhesive can be used. The pressure-sensitive adhesive can be activated by applying pressure on the two components being bonded together and including the adhesive therebetween.

In an alternate embodiment, a polymer layer can be applied between the face members and the core portion that are being bonded together. When activated, either by heat, pressure or any other activation means, the polymer bonds both components together. Simultaneously, the polymer layer can enhance the barrier properties of the resulting composite material.

The composite materials can be either manufacture manually or continuously on any appropriate apparatus (not shown).

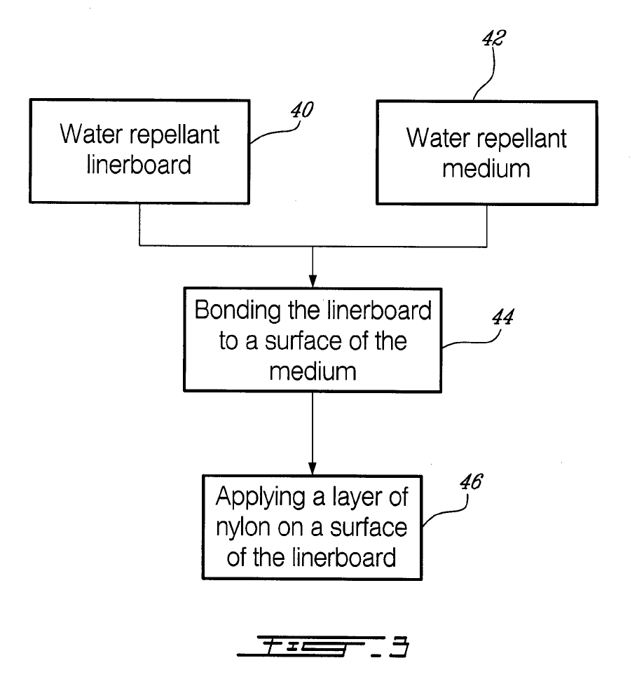

In reference to FIG. 3, an alternative method for manufacturing a water-repellant and gas barrier composite material is described. First, in steps 40 and 42, at least one linerboard and a geometrically patterned layer, i.e. the core portion, having substantial water-repellant properties are provided. The same manufacturing techniques as described above in reference to FIG. 2 and any appropriate alternative can be applied. Then, in step 44, the linerboard is bonded to a surface of the geometrically patterned layer. As for the above described method, bonding of the face member(s) to the core portion can be accomplished by appropriate methods such as by gluing.

In step 46, a nylon coating is applied to a surface of the linerboard, bonded to the geometrically patterned layer. The nylon coating provides substantial gas barrier properties to the resulting panel.

For example, the linerboard and the corrugated layer can have a basis weight of 30-440 g/m2 and 250-440 g/m2 respectively. They can be assembled with the fibers oriented in the same or opposite directions, i.e. 90°. Their water absorption (Cobb test—2 minute) can be approximately 40 g/m2 for the ASA or AKD impregnated linerboard, comparatively to approximately 400 g/m2 without hydrophobic additive impregnation. The linerboard is smooth for easy printing on its surface while the corrugated layer is porous to ensure glue absorption. The ring crush index can vary between 2 and 2.2 for the linerboard and 1.5-1.8 for the corrugated layer. The tensile of the linerboard is relatively high, relatively to the corrugated layer tensile to bear the stresses. It is also possible to print on nylon due to its relatively high surface tension.

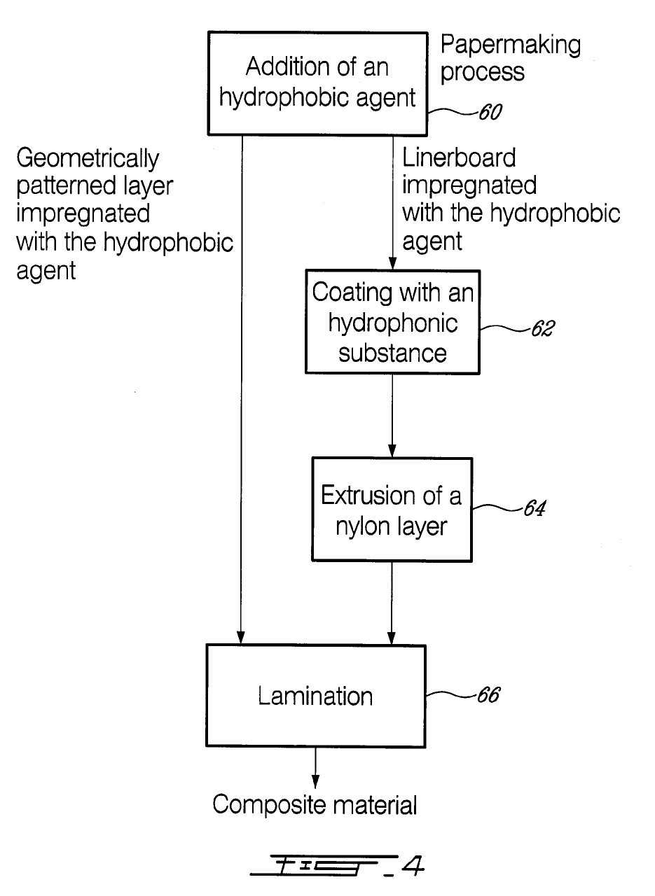

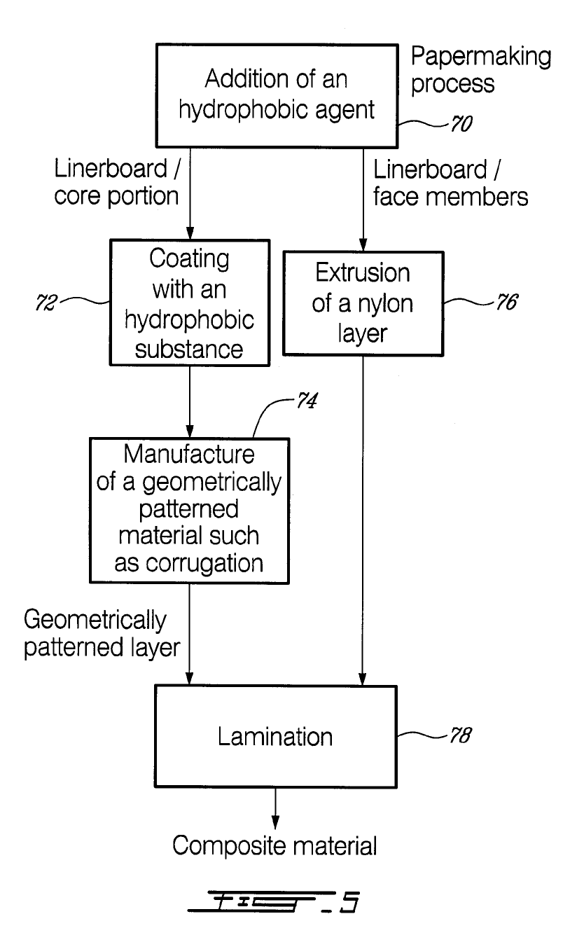

Referring now to FIGS. 4 and 5, there is shown two embodiments of manufacturing processes for manufacturing two embodiments of the composite material. In the embodiment shown in FIG. 4, the face member(s) include(s) an hydrophobic coating while in the embodiment shown in FIG. 5, the core portion includes an hydrophobic coating. It is appreciated that in alternatives embodiments, both the face member(s) and the core portion include an hydrophobic coating or none of the face member(s) and the core portion include an hydrophobic coating.

Referring more particularly to FIG. 4, an hydrophobic agent is added during the papermaking process at the paper machine 60 thereby producing a geometrically patterned layer, i.e. the core portion, and linerboard(s) impregnated with the hydrophobic agent. The linerboard is then coated with an hydrophobic substance 62, which can be the same or vary from the impregnated one. A nylon layer is then extruded to a surface of the linerboard(s) to obtain the face member(s) 64. The face member and the core portion are bonded together to obtain the composite material 66.

Now, referring more particularly to FIG. 5, an hydrophobic agent is added during the papermaking process at the paper machine thereby producing several linerboard(s) impregnated with the hydrophobic agent 70. At least one of the linerboard is first coated with an hydrophobic substance 72, which, as for the previously described embodiment, can be the same or vary from the impregnated one. The coated linerboard is then processed to manufacture a geometrically patterned layer, such as corrugated layer or a honeycomb layer, as the core portion of the composite material 74. A nylon layer is then extruded to a surface of another linerboard to obtain the core portion 76. The linerboard coated with a nylon layer is bonded to the core portion to obtain the composite material 78.

In an alternative embodiment, the composite material can be geometrically patterned layer free, i.e. it can include a linerboard impregnated with an hydrophobic agent and a nylon layer bonded to a surface of the linerboard. The linerboard and the nylon layer being substantially planar. The composite material of this embodiment can include other substantially planar material layers, as for the previously described embodiments. The linerboard can be multi-plies and can include a sizing agent applied between at least two of the plies. The linerboard can include an hydrophobic coating. The nylon layer can be extruded.

A water-repellant and gas barrier composite material as claimed in any one of claims 24 to 28, comprising a water vapor barrier polymer layer laminated between the linerboard and the nylon coating film.

Referring now to FIG. 6, there is shown an example of a container 80 made with a water-repellant and gas barrier composite material 110, which is an alternate embodiment of the composite material 10 described above.

As for the composite material 10, the composite material 110 includes a core portion 112 and two face members 114. The core portion 112 is a honeycomb type material, a geometrically patterned structure, made of a wood fiber based material such as, without being limitative, paperboard, cardboard, kraft paper, recycled paper, medium, chipboard, bleached or not. The core portion 112 defines two opposite substantially planar surfaces, spaced-apart from one another.

The face members 114 include two linerboards, each having an inner surface and an outer surface. A nylon layer 122 is applied to the outer surface of one of the linerboards of the composite material 110. The inner face of the linerboards are bonded to a respective one of the surfaces of the core portion 112. As for the core portion 112, the linerboards can be made of any wood fiber based material such as, without being limitative, paperboard, cardboard, kraft paper, recycled paper, medium, chipboard, bleached or not. Both the core portion 12 and the linerboards 15 are impregnated with a water-repellant additive.

The nylon layer 122 is bonded to the outer surface of the outer linerboard, i.e. the outer surface of the face member 114 constituting the outer wall of the container 80. In other embodiments, it is appreciated that either the outer surface of the outer linerboard, and/or the outer surface of the inner linerboard, and/or the inner surface of the inner linerboard, and any combination thereof can include a nylon layer.

The container 80 includes four side panels 82 defining a peripheral wall, a bottom panel 84 and a top panel 86. Each of the panels 82, 84, 86 defining the container 80 is made of the composite material 110. However, it will be appreciated that, in an alternate embodiment, only one of the panels 82, 84, 86 can be made of the composite material 110.

The thickness of the panels 82, 84, 86 constituting the container 80 can vary. For example, the bottom and top panels 84, 86 can be made with a composite material 110 having a thickness of 1 inch while the side panels 82 can be made with a composite material 110 having a thickness of 0.25 inch. In other embodiments, the thickness of the composite material 110 can vary between 0.2 to 10 inches, for instance.

The containers 80 can be used, for instance, in the food, flower, pharmaceutical industries, etc. The containers 80 can be used for shipping and storing food, particularly perishable foods such as ice-packed chicken, meat, fishery products, fruits and vegetables.

Containers 80 made of the composite material can be used in the perishable goods industry for storing, transporting, and even washing fruits and vegetables for instance. For example, the fruits and vegetables can be collected and packed into the container having a perforation pattern in the bottom panel. For washing the fruits and vegetables, water is sprayed directly inside the container. The substantially water-repellent property of the composite material prevents edge-wicking. Thereby, the container can maintain its integrity even if water has been directly sprayed therein.

The resulting composite material substantially resists to oil and grease, offers gas and water vapor barrier properties, and is water resistant and recyclable. Moreover, it is possible to print directly on the nylon coating.

In addition to providing gas barrier properties to the composite material, applying a nylon coating increases the bursting strength, the tearing strength, the tensile, and the tensile energy absorption (TEA).

When the composite materials have been assembled, they can be cut, or die-cut, printed on their outer surfaces, folded, and shape to create containers or other packages.

Accordingly it is understood that the invention is not limited to the aforementioned composite materials and container configurations and alternatives are possible. The embodiments of the invention described above are intended to be exemplary only.

For example, without being limitative, the wood fiber based materials for the core portion and the face members can be made entirely of recycled material. It can be treated with a water-based coating or a resin coating.

The face members can be structured (for exampled corrugated) or substantially flat.

In an alternative embodiment, the composite material can be single face, i.e. face member and core portion such as corrugated layer, single wall, i.e. face member-core portion-face member, double wall, i.e. face member-core portion-face member-core portion-face member, triple wall, i.e. face member-core portion-face member-core portion-face member-core portion-face member, etc. The thickness, the material, and the structure of the various face members and core portions can differ.

It is appreciated that, in the embodiment wherein the core portion includes a corrugated layer, the corrugation can be B-, C-, E-, F- or any other available flutes. The corrugated layer can be of 33, 45 lbs/1000 ft2 or other basis weight.

The nylon can include polymer additives and colors, for example, without being limitative, an anti-static additive, an anti-fogging agent or a non-slip additive. For example, a composite material wherein the nylon layer(s) includes an anti-static additive can be used for the manufacture of boxes for storing and shipping electronic components.

In an embodiment, an anti-slip additive is added to the nylon to increase its coefficient of friction (C.O.F.). The nylon has a relatively low C.O.F. which typically varies between 0.15 and 0.23. To meet the box board regulation, the nylon C.O.F. should be increased. If it is not increased, stacked boxes might slide and fall on the floor, thereby creating safety issues. The anti-slip additive can be abrasive inorganic masterbatches, for instance, which increase the nylon C.O.F. when added thereto. For example, the additive concentrate, ASC-0600 commercialized by Polyfil Corporation, Techsperse™ commercialized by Techmer Polymer, and some masterbatches manufactured by Ampacet can be used.

Moreover, the composite material 10, 110 can include other material layers than the ones described above. For example, without being limitative, it can include a water vapor barrier polymer layer which increases the water vapor barrier properties of the resulting panel or composite material. Water vapor barrier polymers are characterized by low water-vapor transmission rate (WVTR), which is a measure of the ability to transport moisture through a material of specified thickness. For example, a water vapor barrier polymer can have a WVTR ranging between 20 and 40 g/m2 per day when measured at 100% relative humidity and 100° F. Polymers such as polypropylene (PP), low density polyethylene (LDPE), high density polyethylene (HDPE), linear low density polyethylene (LLDPE) can be used, for instance. If superposed to the nylon layer, these polymers can be modified to facilitate their adhesion to the nylon layer 22. For example, they can be modified with anhydride, such as the polymer commercialized by DuPont™ Bynel® 4288 or Mitsui's ADMER®-AT1000A. The additive can be added to the water vapor barrier polymer during the extrusion, if extrusion is used to apply the latter, for instance.

In an embodiment, the water vapor barrier polymer layer can be inserted between the linerboard 15 and the nylon coating layer 22, for instance. However, it is appreciated that the water vapor barrier polymer layer can be located elsewhere in the composite material structure.

At least one of the wood fiber based core portion and the wood fiber based linerboard of the water-repellant and gas barrier composite material can be impregnated with the hydrophobic additive during the papermaking process. For example, the hydrophobic additive can be added at the size press.

At least one of the linerboard and the geometrically patterned structure can be multi-plies and comprises a sizing agent applied between at least two of the plies.

At least one of the face member and the core portion can include an hydrophobic coating.

The nylon coating film can be extruded to the wood fiber based linerboard. The nylon coating film can be applied to an outer surface of the linerboard.

The face member can include a water vapor barrier polymer layer. The water vapor barrier polymer layer can be located between the wood fiber based linerboard and the nylon coating film. The nylon coating film can be co-extruded with a water vapor barrier polymer layer on the wood fiber based face member.

The wood fiber based geometrically patterned structure can be one of a honeycomb structure and a corrugated structure, for instance.

The scope of the invention is therefore intended to be limited solely by the scope of the appended claims.

1. A water-repellant and gas barrier composite material comprising:
a core portion having a wood fiber based geometrically patterned structure defining two spaced-apart substantially planar surfaces and including an hydrophobic additive; and
a face member mounted to one of the surfaces of the core portion, having a wood fiber based linerboard including an hydrophobic additive and a nylon coating film on a surface of the wood fiber based linerboard.

2. A water-repellant and gas barrier composite material as claimed in claim 1, wherein at least one of the wood fiber based core portion and the wood fiber based linerboard is impregnated with the hydrophobic additive during the papermaking process.

3. A water-repellant and gas barrier composite material as claimed in claim 1, wherein at least one of the linerboard and the geometrically patterned structure is multi-plies and comprises a sizing agent applied between at least two of the plies.

4. A water-repellant and gas barrier composite material as claimed in claim 1, wherein at least one of the face member and the core portion comprises an hydrophobic coating.

5. A water-repellant and gas barrier composite material as claimed in claim 1, wherein the nylon coating film is extruded to the wood fiber based linerboard.

6. A water-repellant and gas barrier composite material as claimed in claim 1, wherein the face member includes a water vapor barrier polymer layer.

7. A water-repellant and gas barrier composite material as claimed in claim 6, wherein the water vapor barrier polymer layer is located between the wood fiber based linerboard and the nylon coating film.

8. A water-repellant and gas barrier composite material as claimed in claim 1, wherein the nylon coating film is applied to an outer surface of the linerboard.

9. A water-repellant and gas barrier composite material as claimed in claim 1, wherein the wood fiber based geometrically patterned structure is one of a honeycomb structure and a corrugated structure.

10. A method for manufacturing a water-repellant and gas barrier composite material, the method comprising:
applying a nylon coating film on a surface of a wood fiber based linerboard to obtain a face member, the linerboard being substantially water-repellant; and
bonding the face member to a surface of a core portion having a wood fiber based geometrically patterned structure, the core portion being substantially water-repellant.

11. A method as claimed in claim 10, wherein the step of applying a nylon coating film comprises extruding the nylon coating film.

12. A method as claimed in claim 10, comprising adding an hydrophobic agent in the paper machine to manufacture at least one of the substantially water-repellant geometrically patterned structure and the substantially water-repellant linerboard.

13. A method as claimed in claim 12, comprising adding the hydrophobic agent in the size press.

14. A method as claimed in claim 10, comprising coating with an hydrophobic agent at least one linerboard for at least one of manufacturing the geometrically patterned structure and manufacturing the face member.

15. A method as claimed in claim 10, comprising applying a sizing agent between at least two plies of a linerboard for at least one of manufacturing the geometrically patterned structure and manufacturing the face member.

16. A method as claimed in claim 10, comprising applying an adhesive to one of the face member and the core portion for bonding the face member to the core portion

17. A method as claimed in claim 10, comprising co-extruding the nylon coating film with a water vapor barrier polymer layer on the wood fiber based face member.

18. A container having a peripheral wall and a bottom wall, at least one of said walls comprising:
a core portion defining two surfaces spaced-apart from one another, the core portion having a wood fiber based geometrically patterned structure and being impregnated with an hydrophobic additive; and
at least one face member mounted to at least one surface of the core portion, at least one face member including a wood fiber based linerboard impregnated with an hydrophobic additive and a nylon coating film laminated to a surface of the wood fiber based linerboard.

19. A container as claimed in claim 18, wherein the bottom wall comprises a perforation pattern allowing a fluid to flow outwardly therefrom.

20. A container as claimed in claim 18, wherein at least one of the linerboard and the geometrically patterned structure is multi-plies and comprises a sizing agent applied between at least two of the plies.

21. A container as claimed in claim 18, wherein at least one of the face member and the core portion comprises an hydrophobic coating.

22. A container as claimed in claim 18, wherein the nylon coating film is extruded.

23. A container as claimed in claim 18, wherein the face member includes a water vapor barrier polymer layer.

24. A water-repellant and gas barrier composite material comprising: a wood fiber based linerboard and a nylon coating film bonded to a surface of the wood fiber based linerboard, the linerboard being substantially water-repellant.

25. A water-repellant and gas barrier composite material as claimed in claim 24, wherein the linerboard is impregnated with an hydrophobic additive.

26. A water-repellant and gas barrier composite material as claimed in one of claims 24 and 25, wherein the linerboard is multi-plies and comprises a sizing agent applied between at least two of the plies.

27. A water-repellant and gas barrier composite material as claimed in any one of claims 24 to 26, wherein the linerboard comprises an hydrophobic coating.

28. A water-repellant and gas barrier composite material as claimed in any one of claims 24 to 27, wherein the nylon coating film is extruded.

29. A water-repellant and gas barrier composite material as claimed in any one of claims 24 to 28, comprising a water vapor barrier polymer layer laminated between the linerboard and the nylon coating film.
